(19) United States
(12) Patent Application Publication
(10) Pub. No.: US 2010/0066089 A1
(43) Pub. Date: Mar. 18, 2010

(54) SUBSEA TURBINE WITH A PERIPHERAL DRIVE

(76) Inventors: Bruce Best, Lee's Summit, MO (US); Brian Haupt, Spring Hill, KS (US)

Correspondence Address: HOVEY WILLIAMS LLP, 10801 Mastin Blvd., Suite 1000, Overland Park, KS, 66210, US

(21) Appl. No.: 12/209,731

(22) Filed: Sep. 12, 2008

(51) Int. Cl. F03B 13/10; F03B 3/06; F03B 15/04

(52) U.S. Cl. 290/52; 415/1; 415/133; 290/54; 415/13

(57) ABSTRACT

A ducted water turbine is configured to be installed in a subsea environment to generate hydroelectric power and broadly includes a turbine housing, a turbine rotor, and a generator. The turbine rotor includes a peripheral rim and a plurality of rotor blades mounted to and extending radially inwardly from the rim. The turbine housing includes a duct that permits water to flow through the housing. The peripheral rim is rotatably mounted in the duct, with the water flow causing the turbine rotor to spin. The turbine rotor is drivingly connected to the generator and powers the generator when the turbine rotor is spun by the water flow.

### BACKGROUND

1. Field

The present invention relates generally to water turbines. More specifically, embodiments of the present invention concern a ducted water turbine that is submerged in a body of water and is operable to be powered by water flow generated by an ocean current.

2. Discussion of Prior Art

A hydroelectric power facility uses water to generate electric power and normally includes a water turbine to convert water power into mechanical power for turning an electrical generator. Water turbines are often utilized in freshwater dams, but have also been developed for use in open water applications to extract power from naturally-occurring water flows, such as tidal flows or underwater currents.

Prior art water turbines and the methods for using water turbines are problematic and suffer from various undesirable limitations. One such limitation is that water turbines fail to efficiently generate mechanical power from the available power provided by a water flow. For instance, conventional turbine rotors become inefficient under off-design water flow conditions and, therefore, fail to produce the desired amount of power. Conventional water turbines, particularly turbine rotors, are also prone to mechanical failures due to harsh and unpredictable environmental conditions.

### SUMMARY

The present invention provides a water turbine that does not suffer from the problems and limitations of the prior art water turbines set forth above.

A first aspect of the present invention concerns a ducted water turbine configured to be powered by water flow in a water body. The ducted water turbine broadly includes a turbine duct, a turbine rotor, and a central housing. The turbine duct presents an inlet, an outlet, and a fore-and-aft extending axial passage fluidly communicating with the inlet and outlet, with the axial passage permitting water flow through the turbine duct. The turbine rotor is positioned between the inlet and outlet and is rotatably mounted in the axial passage so that the turbine rotor is operable to be spun about a rotor axis by water flow through the turbine duct and is thereby powered by water flow. The turbine rotor includes a peripheral rim and a plurality of rotor blades cantilevered from and extending radially inwardly from the peripheral rim to present radially innermost blade tips that cooperatively define an open circular center of the turbine rotor. The central housing is fixed relative to the turbine duct and is substantially coaxial with the axial passage. The central housing extends between the inlet and outlet and through the open circular center, with the turbine duct and central housing configured to cooperatively direct water flow in a direction between adjacent pairs of rotor blades. The central housing presents an annular surface spaced from and extending in a circumferential direction along the blade tips to serve as a blade shroud.

A second aspect of the present invention concerns a ducted water turbine configured to be powered by water flow in a water body. The ducted water turbine broadly includes a turbine duct and a turbine rotor. The turbine duct presents an inlet, an outlet, and a fore-and-aft extending axial passage fluidly communicating with the inlet and outlet, with the axial passage permitting water flow through the turbine duct. The turbine rotor is positioned between the inlet and outlet and is rotatably mounted in the axial passage so that the turbine rotor is operable to be spun about a rotor axis by water flow through the turbine duct and is thereby powered by water flow. The turbine rotor includes a peripheral rim and a plurality of adjustable rotor blades extending radially inwardly from the peripheral rim to cooperatively define an open circular center of the turbine rotor. Each of the adjustable rotor blades is pivotally mounted relative to the peripheral rim to pivot about a substantially radial blade axis and thereby present a corresponding angle of attack relative to the rotor axis.

A third aspect of the present invention concerns a water turbine configured to be submerged in a body of water and powered by water flow. The water turbine broadly includes a turbine rotor and an electrical generator assembly. The turbine rotor is operable to be spun about a rotor axis by water flow and thereby powered by water flow. The electrical generator assembly is drivingly attached to the turbine rotor and is thereby operable to be powered by the turbine rotor. The electrical generator assembly includes a generator housing and an electrical generator drivingly coupled to the turbine rotor. The generator housing presents an internal housing space, with the electrical generator being positioned in the internal housing space. The internal housing space includes pressurized gas at an elevated design pressure configured to be at least as great as the static pressure of the body of water adjacent the generator housing.

A fourth aspect of the present invention concerns a method of using a water turbine operable to be powered by a water flow. The method includes the steps of permitting rotation of a turbine rotor about a rotor axis in response to water flow impinging on the rotor blades, and controlling rotation of the turbine rotor about the rotor axis by pivoting the rotor blades of the turbine rotor about a blade axis while permitting rotation of the turbine rotor.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a perspective view of a ducted water turbine constructed in accordance with a preferred embodiment of the present invention, with a number of ducted water turbines being installed on a seafloor;

FIG. 2 is a front right perspective view of the ducted water turbine as shown in FIG. 1, showing the direction in which water enters an inlet of the turbine and the direction in which water exits an outlet of the turbine;

FIG. 3 is a rear left perspective of the ducted water turbine as shown in FIGS. 1 and 2, showing a foundation of the turbine;

FIG. 4 is a front elevation of the ducted water turbine as shown in FIGS. 1-3;

FIG. 5 is a rear elevation of the ducted water turbine as shown in FIGS. 1-4;

FIG. 6a is a fragmentary perspective of the foundation as shown in FIGS. 1-5, showing a platform and pilings of the foundation, with the pilings being exploded from the platform to show a body and sleeve of each piling;

FIG. 6b is a perspective of the foundation as shown in FIGS. 1-5, showing the platform and pilings and also showing a saddle support of the foundation exploded from the platform;

FIG. 6c is a fragmentary exploded perspective of the ducted water turbine as shown in FIGS. 1-5, showing a turbine duct, a central housing, a rotor, and a generator of the ducted water turbine, with the turbine duct being shown in cross section to depict the central housing and the rotor;

FIG. 7 is a cross section of the ducted water turbine as shown in FIGS. 1-5 and 6c;

FIG. 8 is an enlarged fragmentary cross section of the ducted water turbine as shown in FIGS. 1-5, 6c, and 7, showing the generator and rotor mounted in the turbine duct and drivingly connected to each other;

FIG. 8a is a greatly enlarged fragmentary cross section of the ducted water turbine as shown in FIGS. 1-5, 6c, 7, and 8, showing a blade articulating drive that positions the blades of the rotor;

FIG. 9 is a fragmentary front perspective of the ducted water turbine, with the central housing and turbine duct cross sectioned to show the rotor, as shown in FIGS. 1-5, 6c, 7, 8, and 8a, showing the blade articulating drive shifted to position the rotor blades into a closed operating configuration;

FIG. 10a is an enlarged fragmentary front perspective of the ducted water turbine as shown in FIGS. 1-5, 6c, 7, 8, 8a, and 9, showing the blade articulating drive and the rotor blades in the closed operating configuration; and

FIG. 10b is an enlarged fragmentary front perspective of the ducted water turbine as shown in FIGS. 1-5, 6c, 7, 8, 8a, 9, and 10a, showing the blade articulating drive shifted to position the rotor blades into an open operating configuration.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

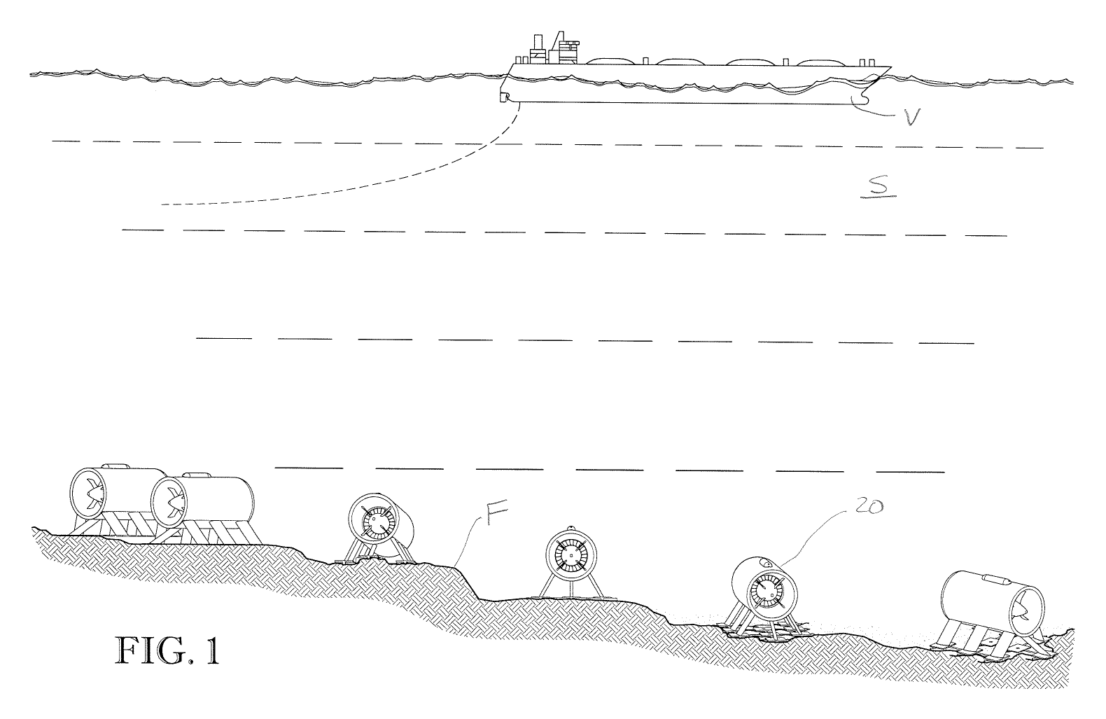

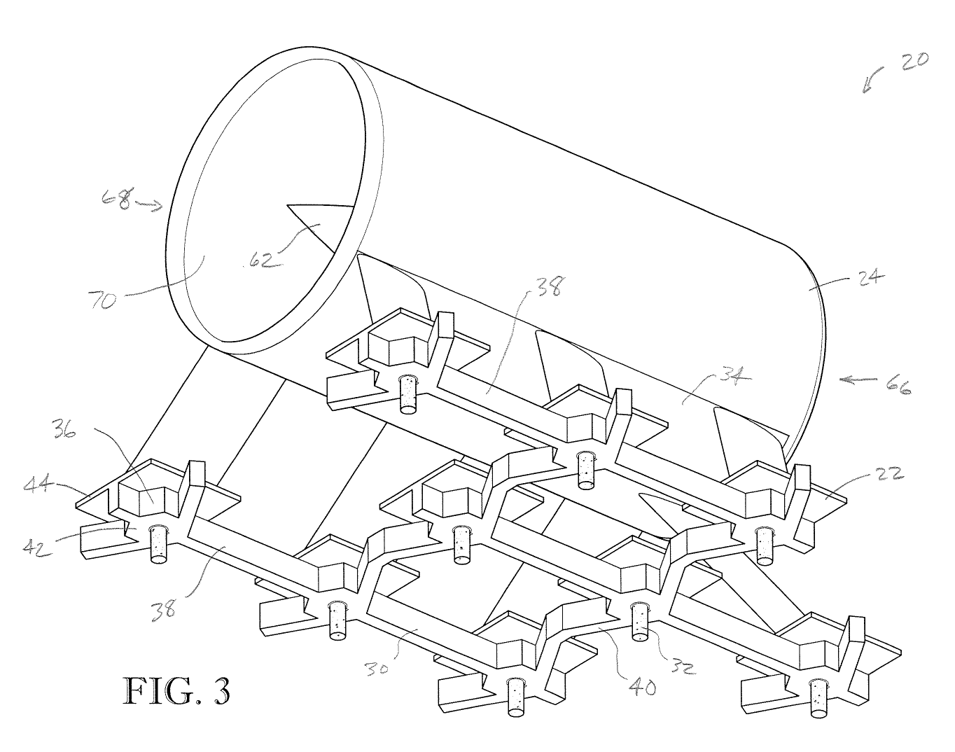

Turning initially to FIGS. 1-3, a ducted turbine assembly 20 is submerged in sea S and preferably installed on the seafloor F to provide hydroelectric power. The ducted turbine assembly 20 is preferably installed in a location where ocean currents, such as the Gulf Stream, are prevalent, with the assembly 20 being positioned to be powered by a substantially uniform ocean current. The illustrated assembly 20 is preferably secured adjacent to the seafloor F at least about 150 feet below the surface of the sea S to limit interference with shipping vessels V, and can be installed up to about 2,000 feet below the surface to be powered by ocean currents, such as the Gulf Stream. However, the assembly 20 could be installed in other submerged locations or configurations without departing from the scope of the present invention. Ocean currents are a preferred type of water flow for the ducted turbine assembly because ocean currents can be relatively uniform over time and can occur at locations around the world. However, the principles of the present invention are also applicable where the ducted turbine assembly 20 is powered by other water flows.

It has been determined that the illustrated assembly 20 is preferably powered by water current that ranges in velocity from about one (1) meter/second to about three (3) meters/second. However, depending on certain design variables, the assembly 20 could be powered by water at a velocity outside of this range. In the illustrated embodiment, a series of ducted turbine assemblies 20 are installed and operably interconnected to provide power, with power lines (not shown) connecting the assemblies 20 and thereby providing power to a remote location. But a power installation could also include a single ducted turbine assembly 20. The ducted turbine assembly 20 broadly includes a foundation 22, a turbine housing 24, a rotor assembly 26, and a generator assembly 28.

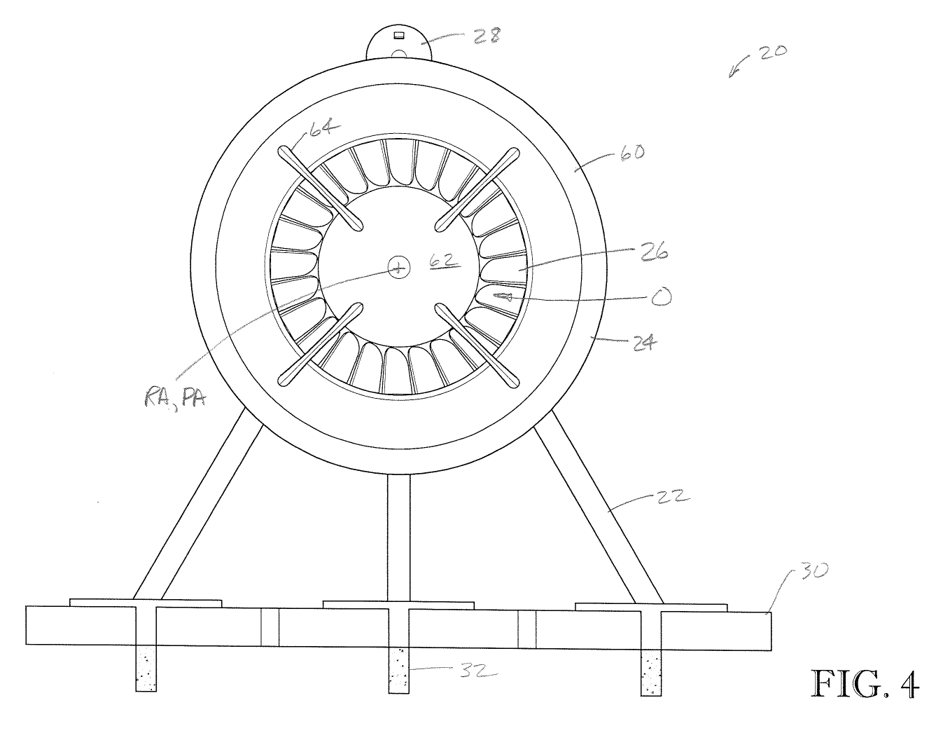

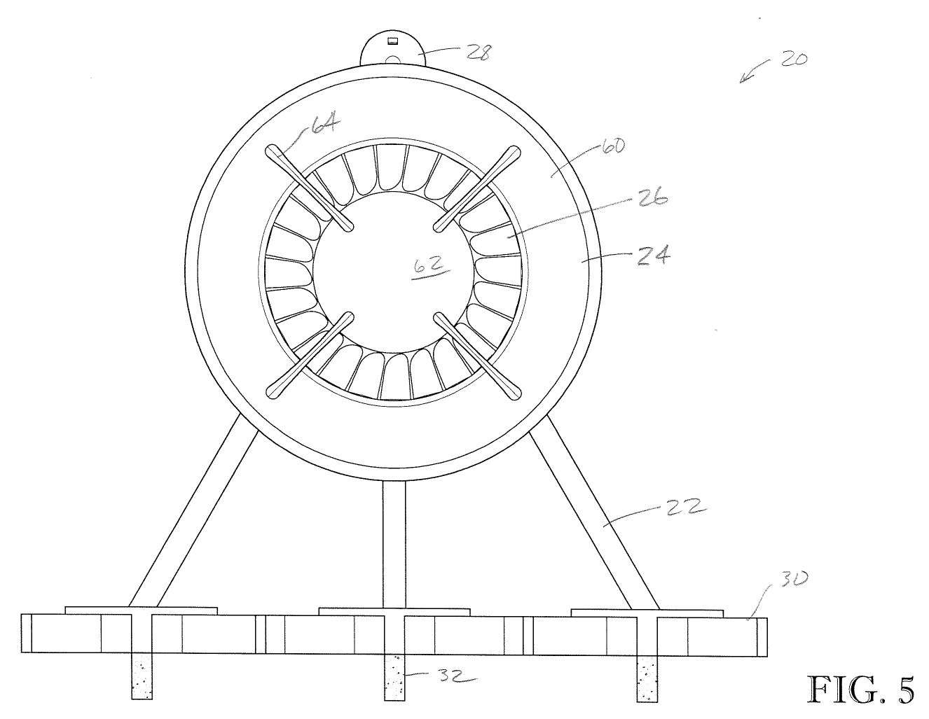

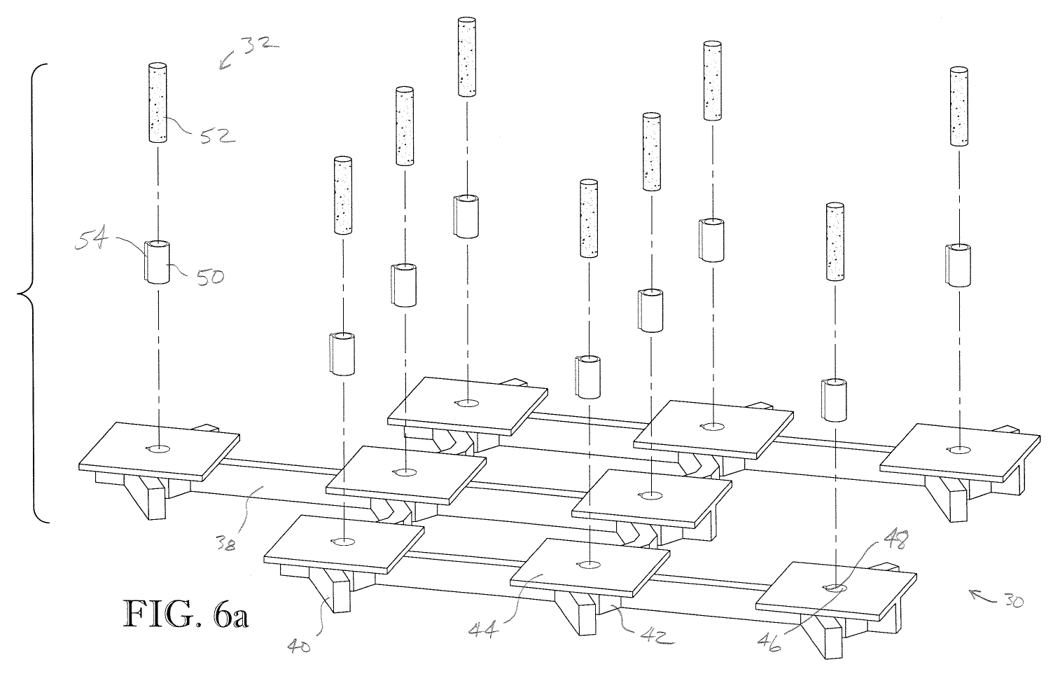

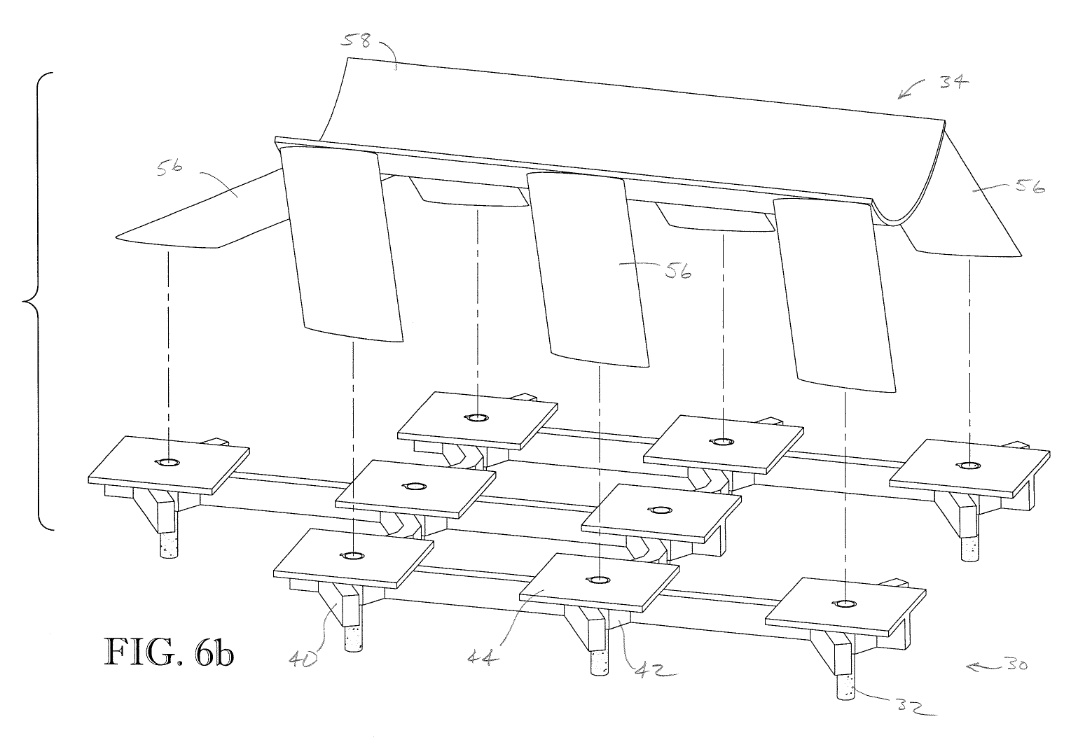

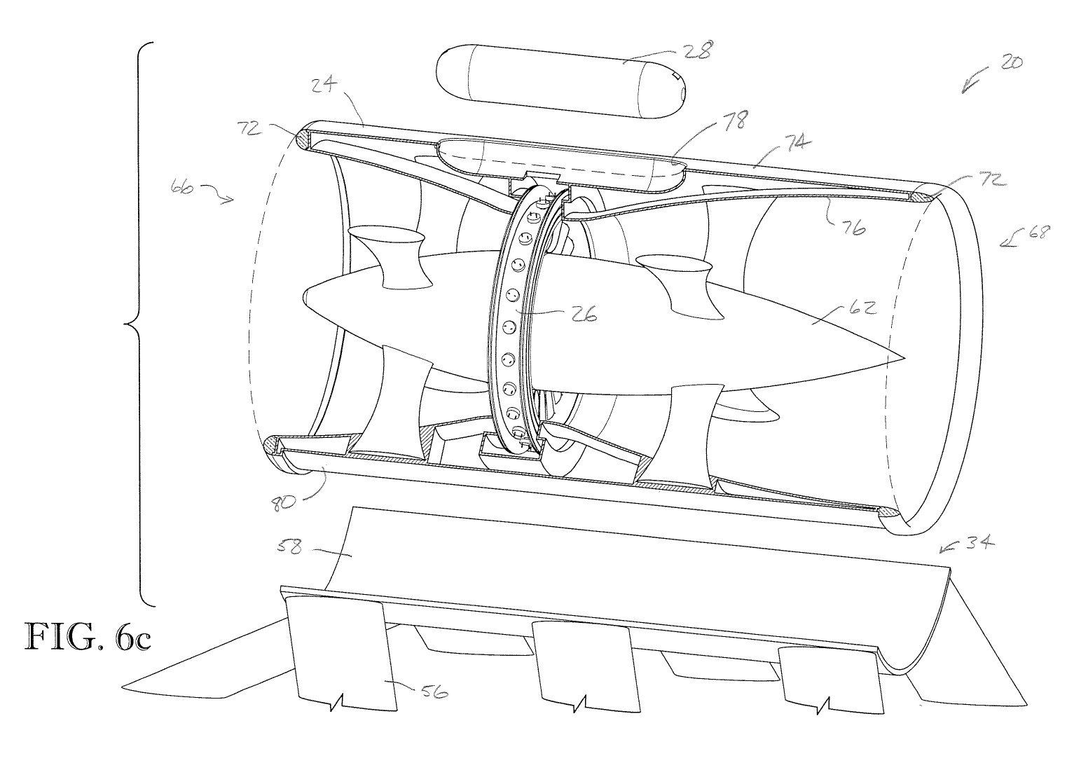

Turning to FIGS. 1-6c, the foundation 22 secures the turbine housing 24 to the seafloor F and restricts movement of the ducted turbine assembly 20 along the seafloor F, as will be discussed in greater detail. The foundation 22 includes a pre-cast platform 30, a plurality of pilings 32 driven into the seafloor F, and a saddle support 34. The pre-cast platform 30 is preferably made from reinforced concrete and includes a plurality of platform sections 36 interconnected by a plurality of upright longitudinal and transverse reinforced concrete footings 38,40 in a substantially unitary form. Each of the platform sections 36 includes a base 42 and a deck 44, with the base 42 and deck 44 cooperatively presenting a bore 46 operable to receive one of the pilings 32. The illustrated bore 46 preferably includes a keyway 48. While the illustrated arrangement of platform sections 36 and footings 38,40 is preferred, it is within the ambit of the present invention to use an alternative arrangement. For instance, some of the sections 36 and footings 38,40 may be separate from one another. Furthermore, the pre-cast platform 30 may not include some of the footings 38,40 depicted in the illustrated embodiment. The pre-cast platform 30 preferably has a longitudinal length of about 210 meters, i.e., along the length of the ducted turbine assembly 20, and a lateral width of about 130 meters. However, the platform 30 could have different dimensions, e.g., the platform 30 could be smaller, without departing from the scope of the present invention.

The platform 30 is secured to the seafloor F by positioning the footings 38,40 in contact with the seafloor F, with the deck 44 being positioned above the base 42. Where the seafloor F is silty or is otherwise soft, the footings 38,40 and base 42 are configured to sink into the seafloor F. The platform 30 is configured to sink into the seafloor F until a lower surface of the decks 44 engage the seafloor F. Thus, movement of the platform 30 along both longitudinal and lateral directions is restricted due to engagement of the seafloor F by the footings 38,40. Pilings 32 include a sleeve 50 that surrounds a reinforced concrete column 52, with the sleeve 50 including a sleeve body and a key 54. Pilings 32 are preferably driven through bores 46 and into the seafloor F to further secure the platform 30, with the key 54 and keyway 48 restricting relative rotational movement between the piling 32 and the platform 30. The illustrated pilings 32 are preferably spaced apart from one another about 60 meters in the longitudinal direction and about 50 meters in the lateral direction, but could be alternatively spaced and positioned relative to the platform 30.

The saddle support 34 is mounted on top of the platform 30 and includes multiple uprights 56 and an arcuate saddle frame 58 attached to the uprights 56. The uprights 56 are each preferably mounted to and supported by a corresponding one of the decks 44. The forward-most upright 56 is supported by the deck 44 spaced in front of the turbine housing 24, with the forward-most upright 56 preferably extending upwardly and rearwardly to a forward end of the saddle frame 58 and thereby stabilize the turbine housing 24 in the longitudinal direction. Three (3) side-mounted uprights 56 are spaced along one side of the turbine housing 24, with lower ends supported by decks 44 spaced outwardly from the turbine housing 24 and extending upwardly and inwardly toward one side margin of the saddle frame 58. Similarly, another three (3) side-mounted uprights 56 are spaced along an opposite side of the turbine housing 24 and extend upwardly and inwardly toward an opposite side margin of the saddle frame 58. In this manner, the side-mounted uprights 56 stabilize the turbine housing 24 in the lateral and longitudinal directions. The illustrated saddle frame 58 comprises a substantially continuous arcuate shell, but it is within the scope of the present invention where the frame 58 includes a plurality of frame sections, e.g., where each pair of side-by-side uprights 56 are interconnected by a corresponding arcuate frame section.

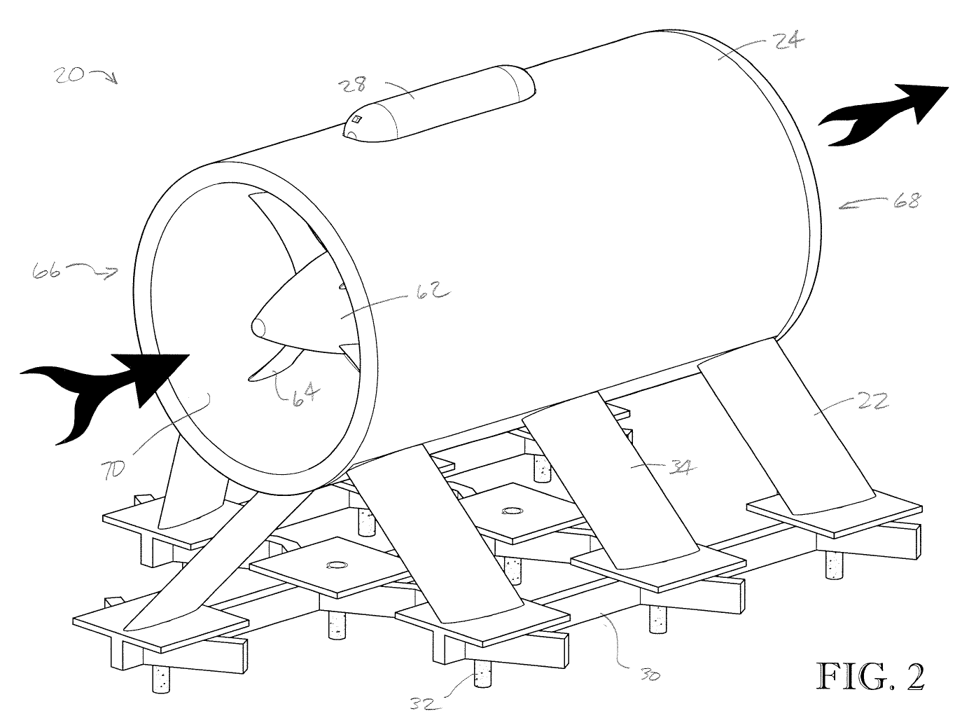

Turning to FIGS. 2-7, the turbine housing 24 is supported on the foundation 22 and serves to rotatably support the rotor assembly 26, as will be discussed in greater detail. The turbine housing 24 broadly includes a turbine duct 60, a central nacelle 62, and struts 64 that support the central nacelle 62 within the turbine duct 60. The turbine duct 60 is generally cylindrical and presents an inlet 66, an outlet 68, and an axial passage 70 that fluidly communicates with the inlet 66 and outlet 68 and extends from the inlet 66 to the outlet 68. The turbine duct 60 preferably has a diameter of about 100 meters and a longitudinal length of about 150 meters. However, the turbine duct 60 could be larger or smaller without departing from the scope of the present invention.

The turbine duct 60 includes a generally cylindrical shell and end caps 72 that are mounted to opposite ends of the shell and serve to protect the leading and trailing edges of the shell. The shell includes a cylindrical outer wall 74 and an inner wall 76 that are joined adjacent the inlet 66 and outlet 68. The outer wall 74 presents an opening 78 that receives the generator assembly 28, as will be discussed further. The outer wall 74 also presents a recessed area 80 that receives the saddle frame 58. The inner wall 76 is annular and presents fore and aft ends 82,84 adjacent the inlet 66 and outlet 68, and a throat 86 spaced between the ends 82,84. The throat 86 presents a throat diameter preferably about two-thirds as large as the diameter of the ends 80,82. Furthermore, the inner wall 76 gradually narrows in diameter from each end 82,84 toward the throat 86 and generally forms the shape of a venturi nozzle. In this manner, the turbine duct 60 is operable to receive a water flow traveling at an ambient velocity adjacent the inlet 66, with the water flow velocity increasing to a maximum nozzle velocity along the throat 86. Furthermore, the illustrated turbine duct 60 permits the water flow velocity to efficiently return to the ambient velocity as the water flow approaches the outlet 68.

The central nacelle 62 is substantially unitary and comprises a streamlined shell having a teardrop-shaped cross section. The nacelle 62 presents fore and aft ends 88,90 and includes a longitudinal nacelle axis running through the ends 88,90. Each of the struts 64 are also substantially unitary and present inner and outer ends 92,94, with a strut axis extending along the length of the strut 64. The struts 64 preferably have a cross-sectional profile with a chord line that is substantially aligned with an axis PA of the passage 70, i.e., the profile presents no angle of attack relative to the passage axis PA. In this manner, the struts 64 only minimally impact the direction of water flow and permit water to flow along the passage axis PA. However, it is also within the scope of the present invention where the struts 64 are constructed as stators to present an angle of attack and thereby direct water flow in an off-axis direction. Furthermore, the struts 64 could be pivotally mounted to pivot about the strut axis to serve as adjustable stators.

The illustrated nacelle 62 is supported at fore and aft locations 96,98 along the axial passage 70 by four struts 64, with the locations 96,98 preferably spaced axially between the inlet 66 and outlet 68 and spaced from the throat 86. In particular, struts 64 are uniformly spaced about the nacelle 62, with outer ends 94 attached to the turbine duct 60 and inner ends 92 attached to the nacelle 62. However, it is also within the scope of the present invention where the nacelle 62 is alternatively supported within the turbine duct 60. For instance, the nacelle 62 could be supported by struts 64 only along one of the locations 96,98. Furthermore, an alternative number of struts 64 could be used to support the nacelle 62. Preferably, the nacelle 62 is positioned so that the nacelle axis is substantially coaxial to the passage axis PA. The illustrated turbine duct 60 and central nacelle 62 cooperatively operate as a nozzle to increase the water flow velocity from the ambient velocity to the nozzle velocity.

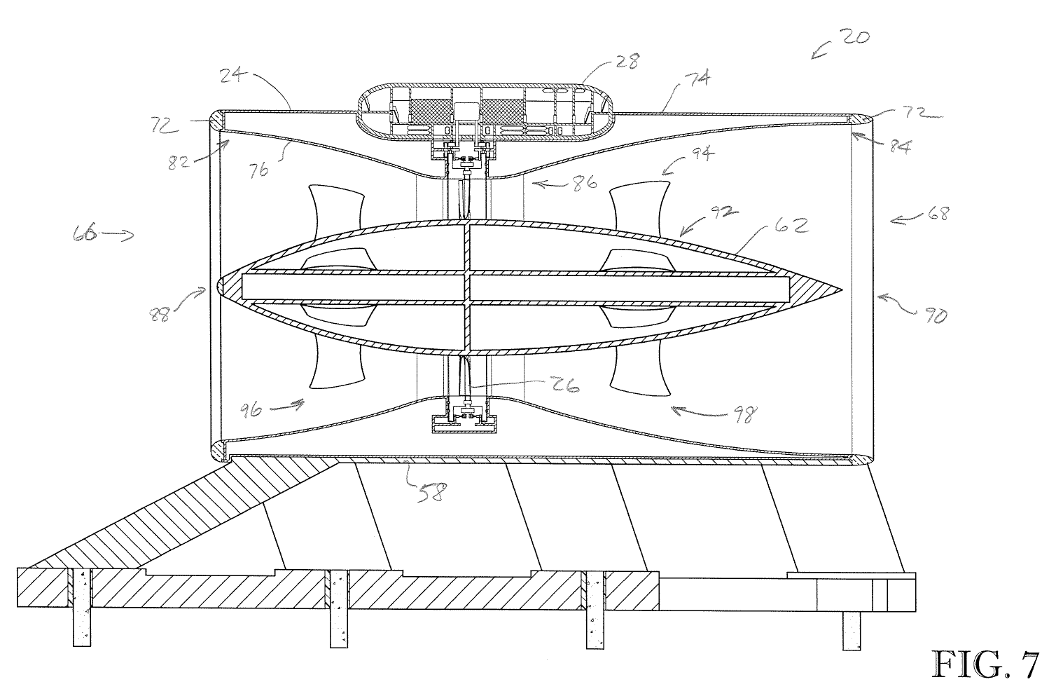

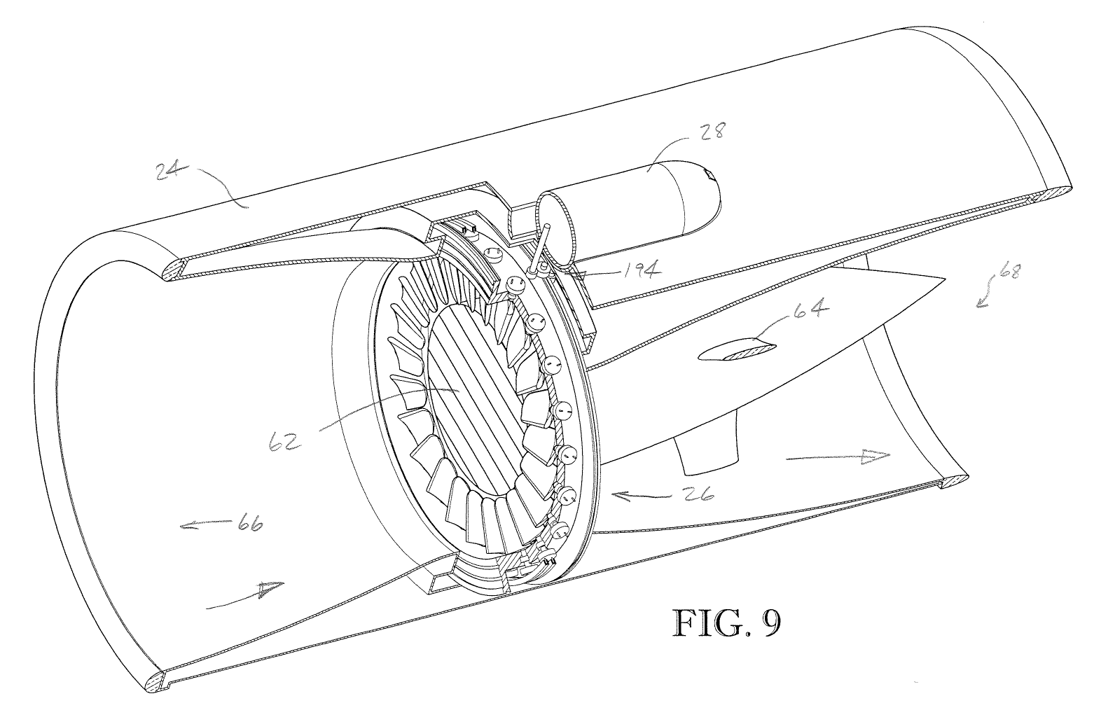

Turning to FIGS. 7-10b, a rotor assembly 26 is configured to be supported in the turbine duct 60. The rotor assembly 26 broadly includes a peripheral rim 100 and a plurality of rotor blades 102 that cooperatively form a turbine rotor, and a blade articulating drive 104. The peripheral rim 100 includes an endless annular body 106 and a pair of endless annular ring gears 108. The annular body 106 includes fore and aft walls 110,112 and sidewall 114 that cooperatively present a channel-shaped cross-section with an outwardly-facing annular opening. The sidewall 114 presents a plurality of bores 116 extending therethrough and spaced circumferentially about the sidewall 114. The ring gears 108 are respectively attached along radially outermost margins of the walls 100,102.

The peripheral rim 100 is preferably rotatably mounted to present a rotor axis RA substantially coaxial to the passage axis PA. In particular, the peripheral rim 100 is rotatably mounted to support walls 118 of the turbine duct 60 by a plurality of bearings 120 and is thereby operable to spin about the rotor axis RA.

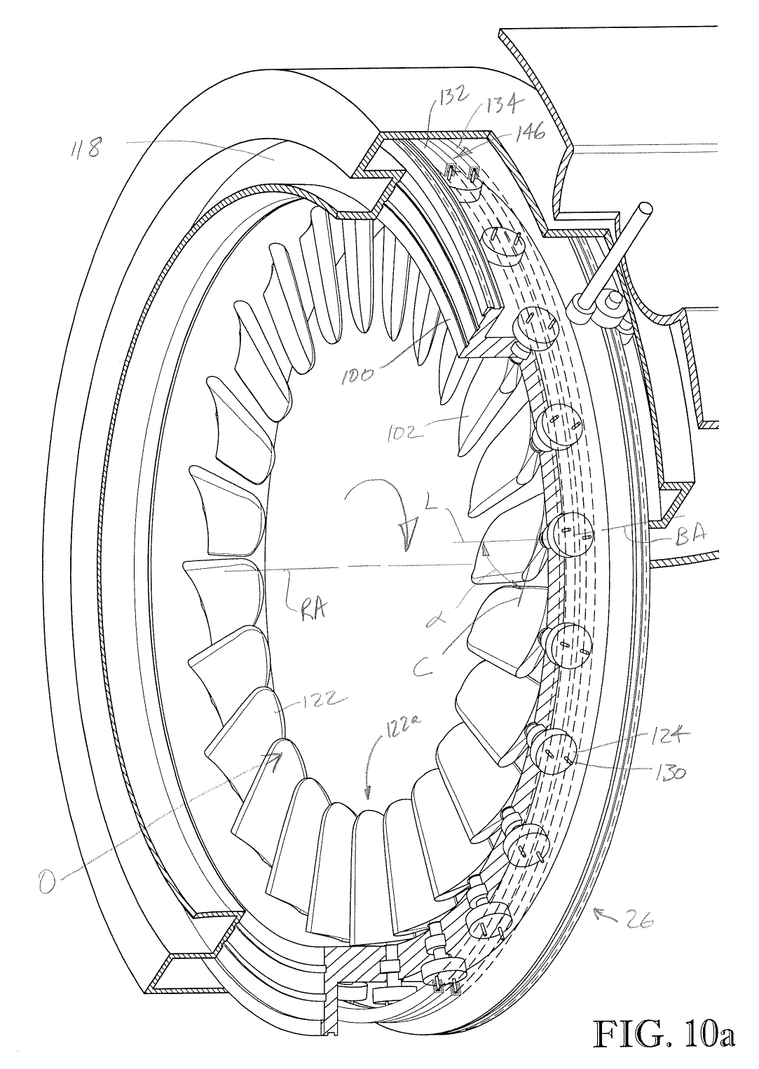

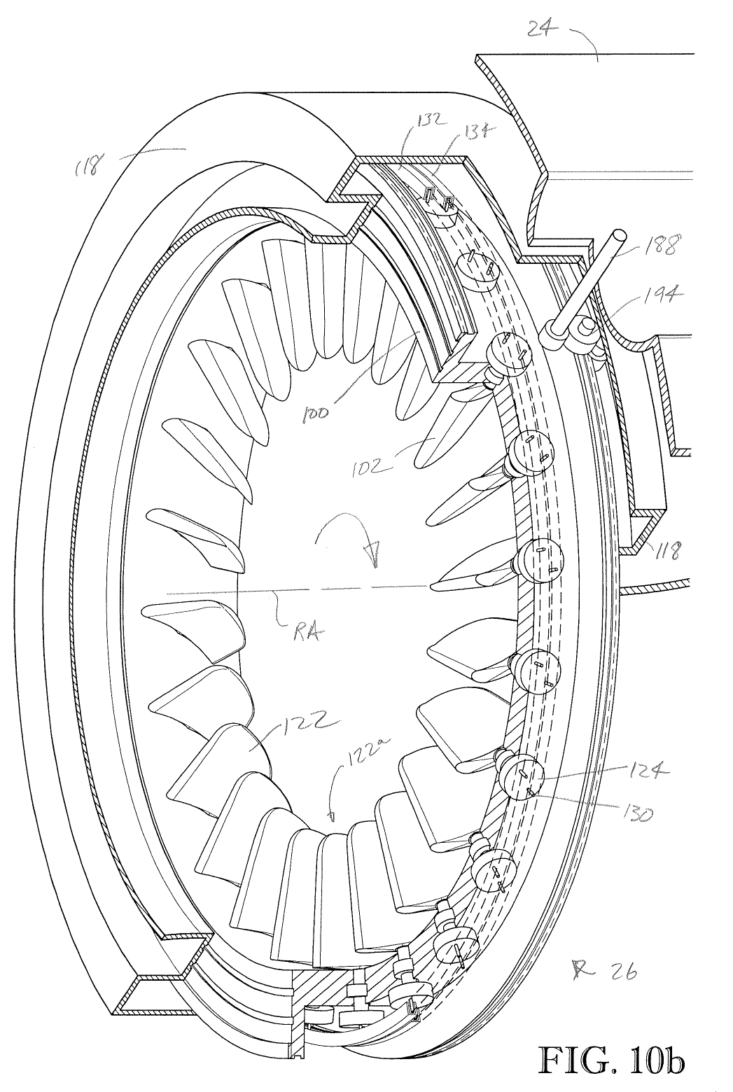

The rotor blade 102 can preferably be pivoted (i.e., feathered) about a blade axis BA and broadly includes a blade 122, a base 124, and a cylindrical stem 126 with one end attached to the blade 122 and the other end attached to the base 124. The stem 126 is rotatably mounted in the bore 116, with a bearing 128 rotatably supporting the rotor blade 102. The base 124 includes a circular flange and studs 130 that extend radially outwardly from the circular flange. As will be discussed further, the studs 130 are configured to be shifted so as to rotate the base 124 and the rotor blade 102 about the blade axis BA. The rotor blade 102 has a blade angle of attack a defined between a chord line C of the blade 122 and the rotor axis RA when the blade 122 is viewed along the blade axis (see FIG. 10a). In other words, the blade angle of attack a is defined between chord line C and a line L parallel to rotor axis RA and intersecting the chord line C. Furthermore, the rotor blades 102 are preferably adjustable so that the blade angle of attack a ranges from about zero degrees, i.e., where the chord line C of the blade 122 is substantially aligned with the rotor axis RA, to about ninety degrees. The rotor blades 102 are rotatably mounted and cooperatively permit adjustment of the rotor assembly 26 in response to various operating conditions, as will be discussed further. However, for other aspects of the present invention, the rotor blades 102 could be fixed to the peripheral rim 100.

The illustrated rotor blades 102 extend radially inwardly from the peripheral rim 100 toward central nacelle 62. The blades 122 present radially innermost blade tips 122a that are positioned adjacent the central nacelle 62, but preferably do not contact the central nacelle 62. Thus, the blades 122 are preferably cantilevered from the stems 126, with the blade tips 122a and central nacelle 62 cooperatively presenting a gap therebetween. It has been determined that the use of cantilevered blades 122 is particularly useful for minimizing the transmission of vibration among rotor blades 102 and thereby restricts blade failure. The illustrated gap has a radial length that is preferably less than half the radial length of the blade 122 from the peripheral rim 100 to the blade tip 122a. More preferably, the radial gap length is less than one-tenth the radial length of the blade 122. The blade tips 122a cooperatively surround and define an open circular center O of the rotor.

The central nacelle 62 is preferably positioned to extend through and substantially entirely occupy the open circular center O and thereby restrict water flow from passing through the open circular center. Furthermore, the central nacelle 62 presents a circumferentially extending annular outer surface that extends along all of the blade tips 122a so that the central nacelle 62 serves as a radially central blade shroud. While the cantilevered rotor blade of the illustrated embodiment is preferred, for other aspects of the present invention the rotor blades 102 could be interconnected along the blade tips by a hub or ring. Also, for some aspects of the present invention, the ducted turbine assembly 20 could be devoid of the central blade shroud or of any other structure that restricts flow through the open circular center O.

The blade articulating drive 104 is mounted to the turbine duct 60 and broadly includes a pair of fore and aft endless guides 132,134 and upper and lower pairs of fore and aft hydraulic cylinders 136,138 that drivingly engage the guides 132,134. The endless guides 132,134 are substantially identical and each have a channel-shaped cross-section with an inwardly-facing annular opening and are positioned side-by-side within the peripheral rim 100. While the illustrated guides 132,134 are substantially rigid, it is within the scope of the present invention where the guides 132,134 are flexible along their circumferential length. The cylinders 136,138 each include a body 140 and a shiftable piston 142, with the body 140 being mounted to cylinder support walls 144 of the turbine duct 60. For each pair of cylinders 136,138, the cylinders 136,138 are positioned oppositely from one another so that each piston 142 extends along the rotor axis RA away from the body 140 and toward the opposite cylinder 136,138. While the blade articulating drive 104 includes upper and lower pairs of cylinders 136,138, it is also within the scope of the present invention to include additional pairs spaced about the rotor axis RA to position the guides 132,134. Also, another type of drive could be used in place of the cylinders 136,138 to shift the guides 132,134.

The endless guides 132,134 are attached to and supported by the pistons 142, with the cylinders 136,138 being operable to shift the guides 132,134 along the rotor axis RA. In particular, the cylinders 136 cooperatively shift the guide 132 and cylinders 138 cooperatively shift the guide 134. However, it is also within the scope of the present invention where only one of the guides 132,134 is shiftable along the rotor axis RA. The guides 132,134 each present a guide axis that extends along the rotor axis RA. The cylinders 136,138 are operable to shift the guides 132,134 from a neutral position where the guide axis and rotor axis RA are coaxial (see FIG. 10b) to an offset position where the guide axis is offset at an angle from the rotor axis RA. Furthermore, the illustrated guides 122,124 can be positioned where the guide axes are offset at an angle from each other (see FIG. 10a), as will be discussed. The illustrated blade articulating drive 104 is configured to be stationary while the rotor blades 102 rotate about the rotor axis RA, but for some aspects of the present invention, the blade articulating drive 104 could be configured to be mounted relative to the peripheral rim 100 and spin about the rotor axis RA with the peripheral rim 100 and rotor blades 102. For instance, each of the rotor blades 102 could be rotated by a respective drive mounted on the peripheral rim 100.

The blade articulating drive 104 is drivingly connected to the rotor assembly 26 to control the rotor blades 102. In particular, the endless guides 132,134 are drivingly connected to the rotor blades 102 by positioning the studs 130 into sliding engagement with the corresponding guides 132,134. As the guides 132,134 are shifted along the rotor axis RA, the guides 132,134 shift the studs 130 axially to rotate the rotor blades 102 and change the blade angle of attack a. To increase the blade angle of attack a, the guides 132,134 are shifted in opposite directions away from each other (see FIG. 10a), while the guides 132,134 are both shifted toward one another to decrease the blade angle of attack a. As the rotor assembly 26 spins about the rotor axis RA, the studs 130 remain in sliding engagement with and rotate relative to the guides 132,134, with the guides 132,134 continuously positioning the rotor blades 102 in the blade angle of attack a.

The rotor assembly 26 is operable to rotate in both a constant blade angle of attack configuration and a variable blade angle of attack configuration. In the constant blade angle of attack configuration, the guides 132,134 are positioned to present a substantially constant gap 146 therebetween along the entire circumference of the guides 132,134 (see FIG. 10b). Thus, as the rotor blades 102 travel along the guides 132,134, the angle of attack remains substantially constant. However, the guides 132,134 can also be positioned to present a variable gap 146 therebetween. In the variable blade angle of attack configuration, the gap 146 varies from a maximum value adjacent a 12 o'clock top position to a minimum value adjacent a 6 o'clock bottom position (see FIG. 10a). In this manner, the guides 132,134 can gradually shift the rotor blades 102 while they are spun so that the blade angle of attack a is at a maximum value at the top position and is at a minimum value at the bottom position. Furthermore, guides 132,134 cause a continuous and gradual change in the blade angle of attack a of all the rotor blades 102 as the rotor blades 102 spin about the rotor axis RA. Thus, rotor blades 102 at the top position can generate more power for a given water velocity than rotor blades 102 at the bottom position for the same water velocity. Because water conditions, such as water velocity can generally increase or decrease with depth, the variable attack angle of the rotor blades 102 is operable to permit adjustments of the turbine rotor in response to changes in water conditions and thereby restrict off-axis loading of the rotor assembly 26.

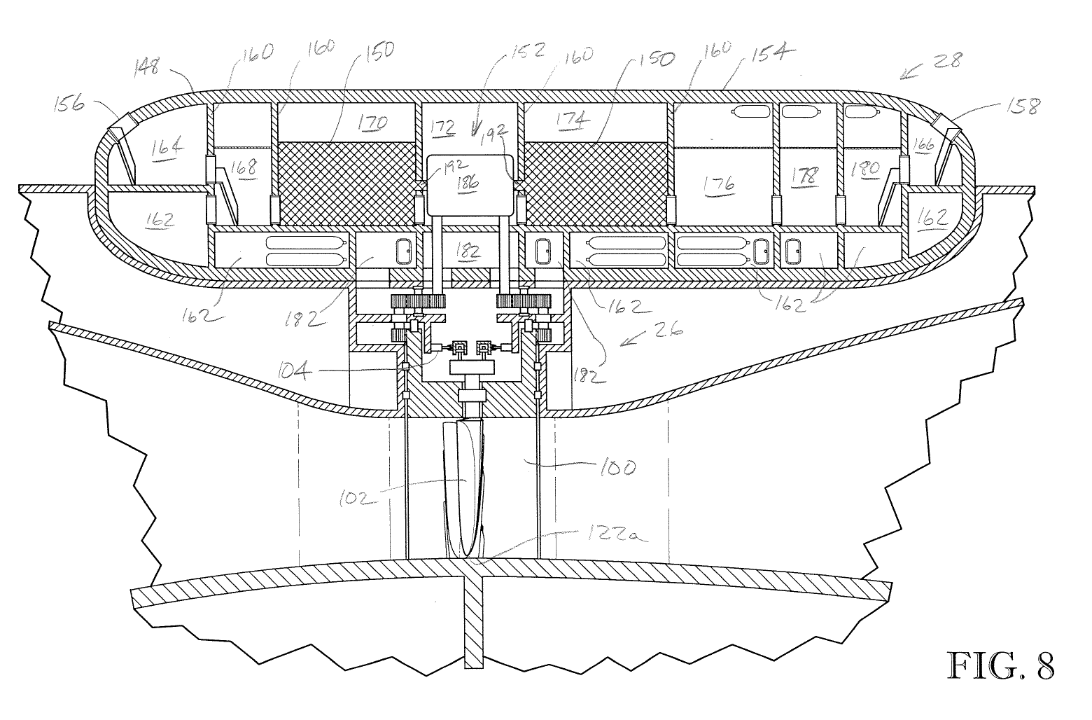

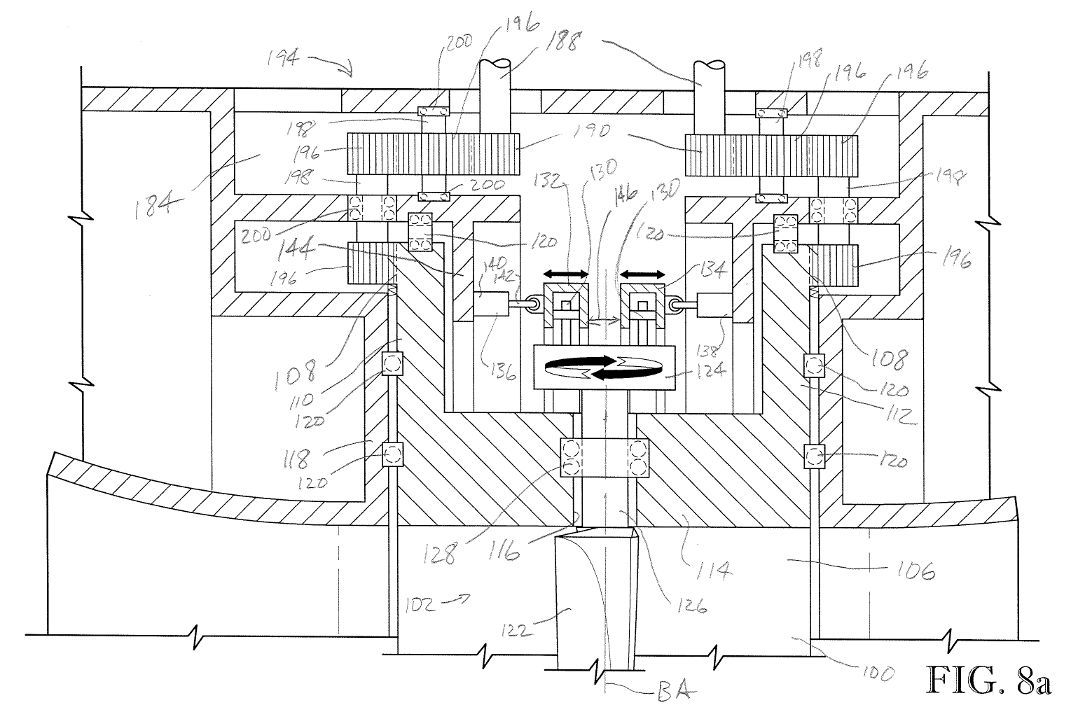

Turning to FIGS. 8 and 8a, the generator assembly 28 is powered by the rotor assembly 26 and serves to generate electrical power. The generator assembly 28 broadly includes a generator housing 148, generators 150, and a transmission 152. The generator housing 148 is a pressure vessel that includes an outer hull 154 that is substantially cylindrical and presents fore and aft docking ports 156,158 adjacent opposite ends of the hull 154 for docking with a submersible vehicle (not shown). The generator housing 148 further includes a plurality of bulkheads 160 that divide the internal hull space into a plurality of chambers. In particular, the generator housing 148 presents storage compartments 162, with some compartments 162 containing fluid storage tanks T, e.g., for gas or liquid storage. The generator housing 148 also defines fore and aft air locks 164,166 that are accessible through respective docking ports 156,158, and pressurized compartments 168,170,172,174,176,178,180.

Pressurized compartments 168,170,172,174,176 are preferably fully pressurized with gas to an elevated housing design pressure. The design pressure is approximately the same as the static water pressure at the water depth adjacent the generator assembly 28, but could be another elevated pressure without departing from the scope of the present invention. Compartments 178,180 are preferably pressurized to a pressure less than the design pressure. In particular, compartment 178 is pressurized to a first intermediate pressure of about two-thirds of the design pressure. Compartment 180 is pressurized to a second intermediate pressure of about one-third of the design pressure. However, the compartments 178,180 could use different internal pressures. In this manner, the compartments 178,180 are operable to serve as decompression chambers.

The generator housing 148 also presents open wells 182 along the bottom of the outer hull 154. The generator housing 148 is positioned within the opening 78 in the turbine duct 60 and attached to the turbine duct 60, with the open wells 182 communicating with an annular space 184 defined between the support walls 118. The open wells 182 permit ingress and egress from within the generator housing 148 to the annular space 184 to provide access to the rotor assembly 26.

The generators 150 are conventional electrical generators and are secured in corresponding compartments 170,174. The generators 150 provide electrical power through lines (not shown) extending from the generator assembly 28 to a remote location. Access to the generators 150 is provided via adjacent compartments 168,176.

The transmission 152 is operable to drivingly interconnect the rotor assembly 26 and the generators 150. The transmission 152 includes a compound transmission 186 with two drive shafts 188 that each support a driven gear 190 and two driven shafts 192 drivingly attached corresponding generators 150. The compound transmission 186 is conventional and operates to transmit power from the drive shafts 188 to either of the driven shafts 192 or both of the driven shafts 192. The compound transmission 186 is positioned in compartment 172 and is positioned between the generators 150, with the driven shafts 192 each extending to the corresponding generator 150.

The transmission 152 further includes gear drives 194 that include spur gears 196 mounted on corresponding intermediate shafts 198. The shafts 198 are rotatably supported by bearings 200. The gear drives 194 drivingly interconnect the ring gear 108 of the peripheral rim 100 and the driven gears 190 to transmit power from the peripheral rim 100 to the compound transmission 186. The principles of the present invention are also applicable where an alternative gear drive interconnects the peripheral rim 100 and the compound transmission 186. Furthermore, the compound transmission 186 could be driven directly by the peripheral rim 100.

While the illustrated ducted turbine assembly 20 includes a single generator assembly 28 generally located adjacent the top of the turbine housing 24, the assembly 20 could include multiple generator assemblies 28 spaced about the rotor assembly 26 and all drivingly connected to the peripheral rim 100 to be powered by the rotor assembly 26.

In operation, the ducted turbine assembly 20 is operable to be powered by water flow from ocean currents. The water flow enters the inlet 66 and travels through the axial passage 70 to the outlet 68. Water flow velocity increases from the inlet 66 to the throat 86 and causes the turbine rotor to spin, with the turbine rotor powering the generator assembly 28. When the ducted turbine assembly 20 is shifted to an operating mode to generate power, the rotor assembly 26 is operable to be used in either the constant angle of attack configuration or the variable angle of attack configuration. Furthermore, the blade angle of attack a of rotor blades 102 is adjustable to optimize turbine rotor efficiency in response to variable water conditions, such as water flow velocity. Yet further, the blade angle of attack a is adjustable to produce a selected amount of power, e.g., to produce only enough power as needed by a power grid. In response to the ducted turbine assembly 20 shifting to a non-operating mode, e.g., for turbine installation or maintenance, the rotor assembly 26 is operable to shift the rotor blades 102 into a neutral position where the blade angle of attack a is substantially zero to restrict rotation of the turbine rotor.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A ducted water turbine configured to be powered by water flow in a water body, said ducted water turbine comprising:
a turbine duct presenting an inlet, an outlet, and a fore-and-aft extending axial passage fluidly communicating with the inlet and outlet, with the axial passage permitting water flow through the turbine duct;
a turbine rotor positioned between the inlet and outlet and rotatably mounted in the axial passage so that the turbine rotor is operable to be spun about a rotor axis by water flow through the turbine duct and is thereby powered by water flow,
said turbine rotor including a peripheral rim and a plurality of rotor blades cantilevered from and extending radially inwardly from the peripheral rim to present radially innermost blade tips that cooperatively define an open circular center of the turbine rotor; and
a central housing fixed relative to the turbine duct and substantially coaxial with the axial passage,
said central housing extending between the inlet and outlet and through the open circular center, with the turbine duct and central housing configured to cooperatively direct water flow in a direction between adjacent pairs of rotor blades,
said central housing presenting an annular surface spaced from and extending in a circumferential direction along the blade tips to serve as a blade shroud.

2. The ducted water turbine as claimed in claim 1,
said central housing including an axial enclosure that substantially restricts water flow through the open circular center.

3. The ducted water turbine as claimed in claim 2,
said central housing including a plurality of struts extending radially between and interconnecting the axial enclosure and the turbine duct.

4. The ducted water turbine as claimed in claim 3,
said struts being positioned fore and aft of the turbine rotor to restrict movement of the axial enclosure relative to the turbine duct along opposite sides of the turbine rotor.

5. The ducted water turbine as claimed in claim 3,
said struts each including a substantially radially extending strut axis and presenting a cross-sectional strut profile along the strut axis,
said strut profile having substantially no angle of attack relative to the rotor axis, with the strut thereby permitting water flow along the rotor axis.

6. The ducted water turbine as claimed in claim 1,
each of said blade tips and said central housing defining a gap therebetween,
said rotor blades presenting a radial length from the peripheral rim to a radially innermost edge of the blade tip, with the gap defining a radial distance less than half the radial length.

7. The ducted water turbine as claimed in claim 1,
said turbine duct at least partly defining inlet and outlet flow areas at the inlet and outlet respectively,
said turbine duct and said central housing cooperatively defining a rotor flow area adjacent the rotor that is less than the inlet and outlet flow areas, with the turbine duct and central housing thereby cooperatively serving as a venturi nozzle with water flow velocity being greater through the turbine rotor than through the inlet and outlet.

8. The ducted water turbine as claimed in claim 1; and
an electrical generator assembly attached relative to the turbine rotor and operable to be powered by the turbine rotor,
said electrical generator assembly including an electrical generator and a transmission drivingly interconnecting the electrical generator and the turbine rotor,
said transmission including a drive element drivingly engaging the peripheral rim and thereby being powered by the turbine rotor.

9. The ducted water turbine as claimed in claim 8,
said peripheral rim including gear teeth spaced circumferentially about the rotor axis,
said drive element including a driven gear in driving engagement with the gear teeth.

10. The ducted water turbine as claimed in claim 8,
said electrical generator assembly including another electrical generator drivingly coupled to the turbine rotor,
said transmission being drivingly connected to and operable to transmit power to at least one of the electrical generators.

11. The ducted water turbine as claimed in claim 10,
said transmission comprising a compound transmission operably coupled to the electrical generators, with the transmission operable to selectively drive the first-mentioned electrical generator and/or the another electrical generator.

12. The ducted water turbine as claimed in claim 11,
said compound transmission including another drive element, with both drive elements drivingly engaging the peripheral rim and thereby being powered by the turbine rotor, and with the compound transmission operable to selectively transmit power from the drive elements to at least one of the electrical generators.

13. The ducted water turbine as claimed in claim 1,
each of said rotor blades comprising adjustable rotor blades that are pivotally mounted relative to the peripheral rim to pivot about a substantially radial blade axis and thereby present a corresponding angle of attack relative to the rotor axis.

14. The ducted water turbine as claimed in claim 1; and
an electrical generator assembly attached relative to the turbine rotor and operable to be powered by the turbine rotor,
said electrical generator assembly including a generator housing and an electrical generator drivingly coupled to the turbine rotor,
said generator housing presenting an internal housing space, with the electrical generator being positioned in the internal housing space,
said internal housing space including pressurized gas at a design pressure at least as great as the static pressure of the body of water adjacent the generator housing.

15. The ducted water turbine as claimed in claim 1; and
a turbine foundation operably coupled to the turbine duct and including a pre-cast foundation section configured to be secured at the bottom of the water body,
said pre-cast foundation section including a plurality of fore-and-aft footings and a plurality of transverse footings, with the footings being interconnected to present a substantially unitary pre-cast foundation section.

16. The ducted water turbine as claimed in claim 15,
said pre-cast foundation section presenting a plurality of openings,
said foundation including a plurality of elongated seafloor anchors extending through respective openings and operable to be driven into and thereby secured at the bottom.

17. A ducted water turbine configured to be powered by water flow in a water body, said ducted water turbine comprising:
a turbine duct presenting an inlet, an outlet, and a fore-and-aft extending axial passage fluidly communicating with the inlet and outlet, with the axial passage permitting water flow through the turbine duct; and
a turbine rotor positioned between the inlet and outlet and rotatably mounted in the axial passage so that the turbine rotor is operable to be spun about a rotor axis by water flow through the turbine duct and is thereby powered by water flow,
said turbine rotor including a peripheral rim and a plurality of adjustable rotor blades extending radially inwardly from the peripheral rim to cooperatively define an open circular center of the turbine rotor,
each of said adjustable rotor blades being pivotally mounted relative to the peripheral rim to pivot about a substantially radial blade axis and thereby present a corresponding angle of attack relative to the rotor axis.

18. The ducted water turbine as claimed in claim 17; and
a blade articulating drive drivingly attached to the rotor blades and configured to selectively pivot the rotor blades about the radial blade axis.

19. The ducted water turbine as claimed in claim 18,
said blade articulating drive including an annular member shiftably attached relative to the peripheral rim,
said annular member drivingly interconnecting the rotor blades with one another and shiftable relative to the rotor blades to pivot the rotor blades about the radial blade axis.

20. The ducted water turbine as claimed in claim 19,
said annular member comprising an endless drive member shiftably attached to the turbine duct, with the turbine rotor being rotatable relative to the endless drive member,
said rotor blades each including a guide element shiftable in an axial direction along the rotor axis to pivot the corresponding rotor blade about the radial blade axis and operably connected to the endless drive member,
said endless drive member defining an annular path about the rotor axis and along which the guide elements are configured to move while the rotor spins,
said endless drive member being shiftable along the axial direction relative to the rotor blades, with the guide elements configured to be driven in the axial direction by the endless drive member to thereby pivot the corresponding rotor blades.

21. The ducted water turbine as claimed in claim 20,
said endless drive member being positioned so that the path of the endless drive member lies in a plane positioned obliquely relative to the rotor axis, with the guide elements each following the path so that the angles of attack are different from one another, and with the guide elements continuously shifting in the axial direction and thereby pivoting the corresponding rotor blades while the rotor spins.

22. The ducted water turbine as claimed in claim 20,
said endless drive member presenting a channel-shaped cross-section, with the guide element being slidably received within the endless drive member.

23. The ducted water turbine as claimed in claim 18,
said blade articulating drive drivingly engaging the rotor blades while the rotor spins, with the blade articulating drive operable to pivot the rotor blades while the rotor spins.

24. The ducted water turbine as claimed in claim 23, said angles of attack of the respective rotor blades being different from one another.

25. The ducted water turbine as claimed in claim 17,
said rotor blades being pivotal into and out of a neutral position with the corresponding angles of attack being substantially zero to restrict rotation of the turbine rotor.

26. The ducted water turbine as claimed in claim 17; and
an electrical generator assembly attached relative to the turbine rotor and operable to be powered by the turbine rotor,
said electrical generator assembly including an electrical generator and a transmission drivingly interconnecting the electrical generator and the turbine rotor,
said transmission including a drive element drivingly engaging the peripheral rim and thereby being powered by the turbine rotor.

27. The ducted water turbine as claimed in claim 26,
said peripheral rim including gear teeth spaced circumferentially about the rotor axis,
said drive element including a driven gear in driving engagement with the gear teeth.

28. The ducted water turbine as claimed in claim 26,
said electrical generator assembly including another electrical generator drivingly coupled to the turbine rotor,
said transmission being drivingly connected to and operable to transmit power to at least one of the electrical generators.

29. The ducted water turbine as claimed in claim 28,
said transmission comprising a compound transmission operably coupled to the electrical generators, with the transmission operable to selectively drive the first-mentioned electrical generator and/or the another electrical generator.

30. The ducted water turbine as claimed in claim 29,
said compound transmission including another drive element, with both drive elements drivingly engaging the peripheral rim and thereby being powered by the turbine rotor, and with the compound transmission operable to selectively transmit power from the drive elements to at least one of the electrical generators.

31. The ducted water turbine as claimed in claim 17; and
an electrical generator assembly attached relative to the turbine rotor and operable to be powered by the turbine rotor,
said electrical generator assembly including a generator housing and an electrical generator drivingly coupled to the turbine rotor,
said generator housing presenting an internal housing space, with the electrical generator being positioned in the internal housing space,
said internal housing space including pressurized gas at a design pressure at least as great as the static pressure of the body of water adjacent the generator housing.

32. The ducted water turbine as claimed in claim 17; and
a turbine foundation operably coupled to the turbine duct and including a pre-cast foundation section configured to be secured at the bottom of the water body,
said pre-cast foundation section including a plurality of fore-and-aft footings and a plurality of transverse footings, with the footings being interconnected to present a substantially unitary pre-cast foundation section.

33. The ducted water turbine as claimed in claim 32,
said pre-cast foundation section presenting a plurality of openings,
said foundation including a plurality of elongated seafloor anchors extending through respective openings and operable to be driven into and thereby secured at the bottom.

34. A water turbine configured to be submerged in a body of water and powered by water flow, said water turbine comprising:
a turbine rotor operable to be spun about a rotor axis by water flow and thereby powered by water flow; and
an electrical generator assembly drivingly attached to the turbine rotor and thereby operable to be powered by the turbine rotor,
said electrical generator assembly including a generator housing and an electrical generator drivingly coupled to the turbine rotor,
said generator housing presenting an internal housing space, with the electrical generator being positioned in the internal housing space,
said internal housing space including pressurized gas at an elevated design pressure configured to be at least as great as the static pressure of the body of water adjacent the generator housing.

35. The water turbine as claimed in claim 34,
said generator housing including a plurality of chambers positioned in the internal housing space, with a first one of the chambers being pressurized to the design pressure and a second one of the chambers pressurized to an intermediate pressure less than the design pressure.

36. The water turbine as claimed in claim 35,
said plurality of chambers including a third chamber, with the intermediate pressure of the second one of the chambers being about two-thirds of the design pressure, and with the third chamber pressurized to a third pressure about one-third of the design pressure.

37. The water turbine as claimed in claim 34,
said turbine rotor including a peripheral rim and a plurality of rotor blades extending radially inwardly from the peripheral rim,
said electrical generator assembly including a transmission drivingly interconnecting the electrical generator and the turbine rotor,
said transmission including a drive element drivingly engaging the peripheral rim and thereby powered by the turbine rotor.

38. The water turbine as claimed in claim 37,
said peripheral rim including gear teeth spaced circumferentially about the rotor axis to serve as a drive gear,
said drive element including a driven gear in driving engagement with the gear teeth.

39. The water turbine as claimed in claim 37,
said electrical generator assembly including another electrical generator drivingly coupled to the turbine rotor,
said transmission being drivingly connected to and operable to transmit power to at least one of the electrical generators.

40. The water turbine as claimed in claim 39,
said transmission comprising a compound transmission operably coupled to the electrical generators, with the transmission operable to selectively drive the first-mentioned electrical generator and/or the another electrical generator.

41. The water turbine as claimed in claim 40,
said compound transmission including another drive element, with both drive elements drivingly engaging the peripheral rim and thereby being powered by the turbine rotor, and with the compound transmission operable to selectively transmit power from the drive elements to at least one of the electrical generators.

42. The water turbine as claimed in claim 34; and
a turbine foundation operably coupled to the turbine duct and including a pre-cast foundation section configured to be secured at the bottom of the water body,
said pre-cast foundation section including a plurality of fore-and-aft footings and a plurality of transverse footings, with the footings being interconnected to present a substantially unitary pre-cast foundation section.

43. The water turbine as claimed in claim 42,
said pre-cast foundation section presenting a plurality of openings,
said foundation including a plurality of elongated seafloor anchors extending through respective openings and operable to be driven into and thereby secured at the bottom.

44. A method of using a water turbine operable to be powered by a water flow, said method comprising the steps of:
(a) permitting rotation of a turbine rotor about a rotor axis in response to water flow impinging on the rotor blades; and
(b) controlling rotation of the turbine rotor about the rotor axis by pivoting the rotor blades of the turbine rotor about a blade axis during step (a).

45. The method as claimed in claim 44,
step (b) including the step of pivoting all of the rotor blades simultaneously.

46. The method as claimed in claim 45,
step (b) including the step of continuously pivoting each of the rotor blades as the turbine rotor spins about the rotor axis.

47. The method as claimed in claim 44,
each of the rotor blades being pivotal about the blade axis to present a corresponding angle of attack relative to the rotor axis,
step (b) including the step of pivoting each of the rotor blades so that the corresponding angles of attack are different from one another.

48. The method as claimed in claim 44; and
(c) sensing a turbine operating parameter selected from the group consisting of a parameter of the water, a parameter of the water turbine, and combination thereof,
step (b) including the step of pivoting the rotor blades in response to the sensed turbine operating parameter of step (c) reaching a predetermined value.

49. The method as claimed in claim 48,
step (c) including the step of measuring velocity of the water flow.

50. The method as claimed in claim 48,
step (c) including the step of monitoring when the water turbine has been shifted into or out of a power generating configuration.

51. The method as claimed in claim 50,
step (b) including the step of pivoting the rotor blades into a neutral position with the corresponding angles of attack being substantially zero, with the step of pivoting the rotor blades into the neutral position being performed in response to sensing when the water turbine has been shifted out of the power generating configuration.
